(19) United States
(12) Patent Application Publication
(10) Pub. No.: US 2018/0356835 A1
(43) Pub. Date: Dec. 13, 2018

(54) Method for Moving, in Particular Controlling or Regulating, a Line of Vehicles

(71) Applicant: Daimler AG, Stuttgart (DE)

(72) Inventors: Ottmar GEHRING, Magstadt (DE); Felix KAUFFMANN, Esslingen (DE)

(73) Assignee: Daimler AG, Stuttgart (DE)

(21) Appl. No.: 16/065,558

(22) PCT Filed: Dec. 1, 2016
(86) PCT No.: PCT/EP2016/002026

§ 371 Date: Jun. 22, 2018

(30) Foreign Application Priority Data
Dec. 23, 2015 (DE) 10 2015 016 758.8

(51) Int. Cl. G05D 1/02; G08G 1/00

(52) U.S. Cl. CPC G05D 1/0287; G05D 2201/0213; G08G 1/22

(57) ABSTRACT

A method for moving a line of vehicles, which has at least a first vehicle and a second vehicle permanently and directly following the first vehicle, includes moving the vehicles at a specifiable, constant distance to each other along a route on the basis of a specifiable overall operating strategy which is assigned to the line of vehicles. For each vehicle of the line of vehicles, a respective individual operating strategy is specified depending on a route profile lying ahead, where the individual operating strategies differ from one another. As part of the overall operating strategy, the distance between the vehicles is increased before the line of vehicles reaches the route profile and each vehicle is moved along the route profile on the basis of the respective individual operating strategy. The line of vehicles is moved on the basis of the overall operating strategy after passing through the route profile.

### BACKGROUND AND SUMMARY OF THE INVENTION

The invention relates to a method for moving, in particular controlling or regulating, a line of vehicles.

Such a method for moving, in particular controlling or regulating, a line of vehicles which has a first vehicle and at least one second vehicle permanently and directly following the first vehicle, is for example to be considered as known already from WO 2015/047177 A1 and WO 2015/047178 A1.

Likewise, US 2015019117 A1, US 2002 069010 A1 and WO 2015 047174 A1 according to the preamble, disclose such a method. In the method, the vehicles designed for example as commercial vehicles are moved at least temporarily at a specifiable, constant distance to each other along a route on the basis of a specifiable overall operating strategy which is assigned to the line of vehicles. This means that the distance remains constant, at least temporarily.

The method is carried out in particular by means of a computing device, in particular an electronic computing device, wherein this computing device for example can comprise at least one individual computing device or respective individual computing devices, in particular control devices, of the respective vehicles. This means that the vehicles are moved, in particular controlled or regulated, by means of the computing device, with the result that the distance is set and kept constant by means of the computing device. In particular a longitudinal dynamics regulation of the vehicles takes place by means of the computing device. The respective longitudinal dynamics of the respective vehicle is set or influenced by means of the computing device as part of such a longitudinal dynamics regulation. “Longitudinal dynamics regulation” is understood to mean that respective driving forces or driving torques for driving the respective vehicles and/or respective braking threes or braking torques for braking the respective vehicles are set or specified by means of the computing device. As a result, it is for example possible that the computing device sets and specifies respective speeds with which the vehicles are moved along the route.

By using the method, it is possible to set the distance between the vehicles to a particularly advantageous and in particular low value, with the result that the vehicles can be moved along the route in a particularly energy-favorable manner, without this adversely affecting driving safety. In other words, it is possible by means of the method to move the vehicles along the route and in so doing keep the distance particularly short, with the result that for example aerodynamic resistance can be kept low. As a result, the energy requirement and in particular the fuel consumption for moving, in particular driving, the vehicles along the route, can be kept small.

Simultaneously, because the method is carried out by means of the computing device, the danger that the short distance between the vehicles leads to a vehicle accident can be kept particularly low, as for example because the longitudinal dynamics regulation takes place by means of the computing device, respective reaction times of respective drivers of the vehicles can be at least substantially ruled out as potential causes of danger or accidents.

In order to move the vehicles along the route at the specifiable distance to each other, for example respective drive trains for driving and/or braking of the vehicles are operated, in particular automatically, by means of the computing device.

Furthermore, DE 10 2014 019 543 A1 discloses a method for operating a drive train of a vehicle, wherein an operating strategy is ascertained for the drive train depending on a route profile lying ahead, and wherein at least one speed trajectory of the vehicle is forecast for the route profile lying ahead by means of a forecast simulation. Furthermore, it is provided that if a specified maximum speed is forecast to be exceeded, a gear of a gearbox of the drive train is ascertained at which, in an overrun mode, exceeding the specified maximum speed can be prevented by an engine braking effect of a combustion engine of the drive train, and a gear shift recommendation for engaging the ascertained gear is generated and/or the ascertained gear is engaged at an ascertained position on the route profile.

Moreover, a method for operating a motor vehicle with a hybrid drive is known from DL 10 2009 033 866 A1, in which a choice is made between a plurality of driving modes. If a normal operating state is chosen when there is a requirement for driving torque, wherein a gear is engaged in a gearbox, a clutch is disengaged and a driving torque is provided by the combustion engine. If there is no requirement for driving torque, a first rolling operating state is chosen in which a drive connection between the combustion engine and a gearbox output shaft is interrupted.

Furthermore, it is provided that, if there is a requirement for driving torque which is below a specified threshold value, a second rolling operating state is chosen in which a gear is engaged in the gearbox, the clutch is engaged, and a driving torque is provided by an electric motor.

The object of the present invention is to further develop a method of the type named at the outset such that the vehicles and thus the line of vehicles overall can be moved in a particularly energy-efficient manner.

In order to further develop a method such that the vehicles and thus the line of vehicles can be moved overall in a particularly energy-efficient manner and thus in a particularly fuel-efficient manner, in particular autonomously or automatically or automatedly, according to the invention, a first step is provided in which a respective individual operating strategy is specified for the respective vehicle of the line of vehicles depending on a route profile lying ahead, in other words arranged before the line of vehicles. In so doing, the individual operating strategies of the vehicles are different. In a second step of the method, the distance between the vehicles is increased before the line of vehicles reaches the route profile, as part of the overall operating strategy. In other words, the route profile lies before the line of vehicles, at least at a first point in time. For example, the respective individual operating strategy is specified at this first point in time. For example, at a second point in time chronologically following the first point in time, the line of vehicles reaches the route profile, wherein the distance between the vehicles is increased before the second point in time and for example at or after the first point in time. For example, the distance firstly has a first value. As part of increasing the distance, the distance from the first value to a second value which is greater than the first value is increased.

The method furthermore comprises a third step in which the respective vehicle is moved along the route profile on the basis of the respective individual operating strategy. At a third point in time chronologically following the second point in time, the line of vehicles has already passed the route profile which was before the line of vehicles at the first point in time, with the result that the route profile is then arranged behind this in the direction. of travel of the line of vehicles, at a third point in time. As a consequence of the movement of the line of vehicles along the route profile, the line of vehicles passes through the route profile, whereby the route profile lies behind this in the direction of travel of the line of vehicles. Furthermore, the method according to the invention comprises a fourth step in which the line of vehicles is moved on the basis of the overall operating strategy after passing through the route profile.

The line of vehicles consists of at least two vehicles, wherein the second vehicle permanently and directly follows the first vehicle. By “permanently” it is meant that the two vehicles follow each other in an uninterrupted manner over the period of time of the application of the method according to the invention. By “directly” it is meant that the second vehicle follows the first vehicle immediately, thus during the course of the method, no further vehicle in the line is arranged between the first and the second vehicle, and that the sequence of the two vehicles is also not changed.

The object of the invention is to move the line of vehicles on the basis of the overall operating strategy, wherein the distance belongs to, or is part of, the overall operating strategy. By moving or driving the line of vehicles on the basis of the overall operating strategy, the distance can for example be kept particularly short, with the result that the line of vehicles particularly can be moved along the route in a particularly energy-efficient manner and thus in a particularly fuel-efficient manner. As outlined in conjunction with the prior art, the overall operating strategy can be carried out, i.e., the line of vehicles can be moved, on the basis of the overall operating strategy, with the result that the overall operating strategy is carried out for example by means of a computing device. The computing device is for example an electronic computing device and/or can comprise at least one computing device from at least one of the vehicles and/or respective computing devices, in particular electronic computing devices, such as for example control devices, of the respective vehicles. As a result, the respective vehicles are moved as part of the overall operating strategy or as part of the method, for example autonomously or automatically or automatedly, by means of the computing device. The method is a predictive operating strategy for, for example, automated moving, in particular driving, the line of vehicles, as the route profile lying ahead is taken into consideration when moving the line of vehicles, although the line of vehicles has not yet reached the route profile but will reach it only in the future.

For example, longitudinal dynamics regulation is carried out by means of the computing device, with the result that the line of vehicles is controlled or regulated for example by means of the computing device. The computing device sets a driving force or a driving torque for driving the respective vehicle and/or a respective speed of the respective vehicle as part of the longitudinal dynamics regulation. Alternatively, or additionally, it is possible that the computing device sets a braking force or a braking torque for braking the respective vehicle, as part of the longitudinal dynamics regulation. Through this, for example the respective vehicle can be moved autonomously or automatically as part of the overall operating strategy or as part of the method, by means of the computing device, with the result that the vehicles can be moved in only the short distance between each other. As a result, in particular the aerodynamic resistance can be kept low. Simultaneously, it is possible to move the vehicles particularly safely.

Furthermore, the object according to the invention is to suspend or relax, at least temporarily, the overall operating strategy, and to move the vehicles at least temporarily on the basis of the respective individual operating strategies, in particular automatically or autonomously or semi-autonomously, wherein these individual operating strategies differ from one another. To achieve the respective individual operating strategies, the distance is increased or expanded, with the result that the respective vehicle can be moved, in particular automatically or autonomously, on the basis of its respective, proprietary, and optimized individual operating strategy. As a result, it is for example possible to take into consideration different prerequisites or boundary conditions, in particular different states of the vehicles, as part of the movement of the line of vehicles or respective vehicles along the route profile.

As part of carrying out the respective individual operating strategy, however, the overall operating strategy is maintained, because bringing together the vehicles or the individual operating strategies to form the uniform overall operating strategy after the end of the respective individual operating strategies, i.e., after passing through the route profile, is established already before passing through or travelling the route profile, or is already provided before this point, This means that the individual operating strategies can be considered as sub-strategies, during the execution of which the overall operating strategy, which is an overall driving strategy, is temporarily interrupted, with the exception that the individual operating strategies are subordinated or at least relaxed. The individual operating strategies are established from the overall operating strategy or as part thereof, in order that a separation of the vehicles, i.e., an increase in distance, can be coordinated or matched to one another there for the first time.

The vehicles of the line of vehicles form a formation which is limited, extended, or loosened, for example chronologically and/or spatially, and for example divided into sub-formations or partial formations or small formations or individual vehicles, before reaching the route profile, with the result that these sub-formations or small formations or individual vehicles can be moved along the route profile, each particularly in an energy-efficient manner, on the basis of the respective individual operating strategy. As a result, the total energy requirement required for moving the vehicles or the line of vehicles as a whole along the route profile can be minimized. When passing through the route profile, i.e., when carrying out the respective individual operating strategy, the formation or the line of vehicles is, as a whole, in particular chronologically and/or spatially, more independent than before, and thereafter, when carrying out the overall operating strategy, but the overall operating strategy is not completely set aside or relaxed, as a reunification of the vehicles to the formation establishes as part of the execution of the overall operating strategy, after passing through the route profile, already before or while increasing the distance. Thus, the individual operating strategies can also already be predetermined or specified as individual or group strategies, while or before increasing the distance, and for example be communicated to the respective, individual vehicle. The individual operating strategies are then predetermined for example also to determine a separation or division of the formation by increasing the distance, which strategies are maintained or carried out when passing through the route profile, i.e., when moving the respective vehicles along the route profile. Overall energy consumption can thus be kept low.

Increasing the distance before moving the vehicles along the route profile and thus before carrying out the respective individual operating strategies is carried out in order for example to prevent an undesired, mutual impairment of the vehicles if these are moved along the route profile. As a result, it can for example be avoided that the second vehicle is checked by the first vehicle or moved past the first vehicle. By increasing the distance and carrying out the individual operating strategies, it is possible that the vehicles for example do not need to be moved on the same side of the route profile with an identical or analogous driving strategy, but the driving strategies or individual operating strategies may differ, with the result that the vehicles are moved at at least one identical point of the route profile in different ways as part of the respective individual operating strategies. As a result, for example the energy consumption of the respective vehicle can be minimized, with the result that the overall energy consumption of the line of vehicles can be minimized overall.

In order to move the line of vehicles particularly in an energy-efficient manner, in particular for regulating or controlling, it is provided in an advantageous embodiment of the invention that the distance is reduced after starting the route profile, i.e., for example at the third point in time. As a result, the whole line of vehicles can be moved again after carrying out the respective individual operating strategies, on the basis of the overall operating strategy particularly in an energy-efficient manner, in particular autonomously or automatically. The third point in time can take place when driving through the route profile or also once the route profile has been driven through.

It has been shown to be particularly advantageous if the individual operating strategies differ from one another in terms of the speeds with which the respective vehicles are moved along the route profile. In other words, the individual operating strategies have for example different speed profiles or different speed trajectories, on the basis of which the vehicles are moved with respective speeds along the route profile. The speeds of the vehicles thus differ from one another at at least one point of the route profile. As a result, different boundary conditions or different statuses of the vehicles can for example be taken into consideration in order to move the respective vehicle per se particularly in an energy-efficient manner. Overall energy consumption can thus be kept low. Alternatively or additionally, it is conceivable that the individual operating strategies differ from one another in the respective accelerations with which the vehicles are accelerated along the route profile. Such an acceleration is understood to mean a positive acceleration by means of which the speed of the respective vehicle is increased. Furthermore, respective acceleration is understood to mean a negative acceleration by means of Which the speed of the respective vehicle is reduced, i.e., by means of which the respective vehicle is braked. Due to these differences in speed or acceleration, it is for example possible to take into consideration different weights and/or different driving resistances of the vehicles in order to be able to move, in particular drive, the vehicles and thus the line of vehicles overall particularly in an energy-efficient manner.

“Moving the respective vehicle or line of vehicles” is understood to mean that, as part of the method, for example a respective drive train is operated for driving and/or braking the respective vehicle by means of the computing device, in particular automatically or autonomously. As a result, it is for example possible to accelerate and/or brake the respective vehicle without a driver of the respective vehicle being required to do anything to achieve this. As already indicated, the computing device can comprise exactly one computing device of one of the vehicles or respective individual computing devices of the vehicles. Alternatively or additionally, it is conceivable that the computing device for carrying out the method, i.e., for moving, in particular controlling or regulating, the vehicles and thus the line of vehicles, is a computing device, in particular an electronic computing device, which is external to the vehicles. For example, the computing device controls actuators of the respective vehicle, with the result that driving forces or driving torques for driving the respective vehicle and/or braking, forces or braking torques for braking the respective vehicle can be effected by means of these actuators. As the actuators are triggered by the computing device, an acceleration and/or a braking of the respective vehicle is effected by means of the computing device via the respective actuators.

By extending or increasing the distance between the vehicles it is possible that the respective, individual vehicle can implement its own optimized driving strategy for example on a section of the route having the route profile, in particular chronologically and/or spatially limited, with the result that the energy consumption of the respective, individual vehicle and thus the energy consumption of the line of vehicles overall can be kept low. The method according to the invention thus links the advantages of a line of vehicles, also simply called the line, with the advantages of different operating strategies for moving the individual vehicles of the line, with the result that, in spite of driving the vehicles in the line, an energetic optimization of the individual vehicles can take place, wherein this energetic optimization can be used for the whole line, with the result that, compared with the prior art, a further improvement of the energy consumption can be achieved when driving in convoy.

A further embodiment is characterized in that the line of vehicles has at least one third vehicle driving in front of the first vehicle, with the result that the first vehicle thus follows the third vehicle. Furthermore, the line of vehicles has at least one fourth vehicle following the second vehicle, with the result that the second vehicle drives in front of the fourth vehicle. The previous and subsequent statements in respect of the first vehicle and second vehicle can also be transferred directly to the third vehicle and fourth vehicle. Thus, for example the first vehicle and the third vehicle or the second vehicle and the fourth vehicle are moved at least temporarily at a specifiable, constant distance to each other along the route on the basis of the specifiable overall operating strategy which is assigned to the line of vehicles. Alternatively or additionally, it is conceivable that for the respective third vehicle or fourth vehicle, a respective individual operating strategy is specified depending on the route profile lying ahead, wherein the individual operating strategies of the vehicles differ from one another.

As part of a fifth step it is provided that, when moving along the route profile, the first vehicle and the third vehicle form a first part-line in which the first vehicle and the second vehicle are moved along the route profile at a second distance to each other. Furthermore, preferably a sixth step is provided in which, when driving the route profile or when moving along the route profile, the second vehicle and the fourth vehicle form a second part-line in which the second vehicle and the fourth vehicle are moved along the route profile at a third distance to each other. The first part-line is for example a previously mentioned, first sub-formation or small formation which comprises at least the first and third vehicle. The second part-line is for example a previously mentioned second small or sub-formation which comprises at least the second and fourth vehicle. Furthermore, it is preferably provided that at least after increasing the first distance and preferably before passing through the route profile or before the third point in time, the first distance is greater than the second distance, and greater than the third distance. The first vehicle is for example the last vehicle in direction of travel of the first part-line, wherein for example the second vehicle is the lead vehicle of the second part-line, with the result that for example no further vehicle of the line of vehicles drives between the first vehicle and second vehicle. The part-lines are thus separated from one another by the first distance between the first vehicle and the second vehicle.

The third vehicle is separated from the first vehicle by the second distance within the first part-line. The second vehicle is separated from the fourth vehicle by the third distance within the second part-line. The first distance is greater than the second distance and third distance during the respective movement of the respective part-line along the route profile and after increasing the first distance. For example, it is provided that the first part-line is moved along the route profile on the basis of the first individual operating strategy, wherein the second part-line is moved along the route profile on the basis of the second individual operating strategy, which is different from the first individual operating strategy. It is thus conceivable, for example, to move the respective vehicles of the respective part-line along the route profile in an identical or analogous manner, however, the part-lines are moved along the route profile in different manner, in particular at different speeds, in relation to each other. As a result, overall energy consumption can be kept particularly low.

In order to keep the energy consumption particularly low while the part-lines are moved along the route profile, it is preferably provided that the second distance and/or the third distance remains at least substantially constant at least during the movement of the respective part-lines along the route profile.

Furthermore, it has been shown to be particularly advantageous if, after passing through the route profile and after reducing the first distance, this corresponds to the second distance and the third distance. In other words it is, for example, provided to move the part-lines, i.e., the first, second, third, and fourth vehicle, after passing through the route profile, on the basis of the overall operating strategy, in particular for regulating and controlling, wherein it is preferably provided to move the at least four vehicles of the line of vehicles such that the vehicles are each at a constant distance from one another, in pairs. As a result, the entire line of vehicles can be moved in a particularly energy-efficient manner.

A further embodiment is characterized in that the respective individual operating strategy and/or the overall operating strategy are ascertained depending on a respective weight of the vehicle. If one of the vehicles for example has a particularly high weight, then this weight can for example be used with a decline in order to produce a high speed of the vehicle at only a low energy expenditure. As the first distance is increased before reaching the route profile, this vehicle can be brought to a high speed due to its heavy weight, without being impaired by a vehicle of the line of vehicles which is driving in front of it.

Alternatively or additionally, it is provided that the respective individual operating strategy and/or the overall operating strategy are ascertained depending on at least one friction value characterizing a friction of the respective vehicle and/or depending on a respective driving resistance of the respective vehicle. As a result, respective, individual boundary conditions or states or prerequisites of the vehicles can be taken into consideration, in order to achieve a particularly energy-efficient respective individual operating strategy, with the result that this respective, energetically optimized individual operating strategy can be used to achieve a particularly efficient overall operating strategy.

Furthermore, it has been shown to be particularly advantageous if the respective individual operating strategy and/or the overall operating strategy are ascertained depending on the wind regime in the environment of the respective vehicle. For example, information about the wind regime or the actual wind regime itself can be ascertained by means of at least one sensor of the respective vehicle or retrieved from a computer network. By taking into consideration the wind regime, the respective overall operating strategy and/or individual operating strategy can be designed particularly advantageously, in order to achieve an energy-efficient operation.

Alternatively or additionally, it is provided that the respective individual operating strategy and/or the overall operating strategy are ascertained depending on the number of vehicles of the line of vehicles and/or depending on a respective length of the respective vehicle. As a result, it is for example particularly advantageously possible to exploit respective boundary conditions or prerequisites in order to operate the respective vehicle particularly energy-efficiently, without the vehicles mutually influencing the line of vehicles.

Furthermore, it has been shown to be particularly advantageous if the respective individual operating strategy and/or the overall operating strategy are ascertained depending on a traffic situation. Information about the current traffic situation can be retrieved, in particular wirelessly, for example from a computer network such as the Internet. By taking into consideration the traffic situation, the respective individual operating strategy or overall operating strategy can be designed particularly efficiently, wherein at the same time the danger of a collision with other road users can be kept particularly low.

In a further embodiment of the invention, the overall operating strategy and/or the respective individual operating strategy are ascertained by means of a forecast simulation in which the movement of the line of vehicles along the route profile is simulated before the vehicles move along the route profile. As a result, it is for example possible to calculate an energy requirement for moving the line of vehicles along the route profile or at least an energy value characterizing the energy requirement, by means of the forecast simulation. Furthermore, it is as a consequence possible to minimize the energy requirement or the energy value. The energy requirement is influenced by triggering or setting the actuators, and can be minimized in that, using the forecast simulation, it is ascertained or calculated, before the line of vehicles actually reaches the route profile, in what way the actuators need to be triggered and thus in what way the respective vehicle needs to be moved along the route profile in order to keep the energy requirement or energy consumption particularly low. In particular, the forecast simulation is linked to an optimization or heuristics, wherein for example a consideration there is a weighing up between the aerodynamic advantage over short distances and the kinematic advantage over longer distances.

Finally, it has been shown to be particularly advantageous if the route profile lying ahead comprises at least one road sign and/or at least one light-signal system and/or a junction and/or an incline and/or a decline and/or a bend and/or a dip and/or a crest. As a result, the overall operating strategy or the individual operating strategy can be tailored and particularly advantageously adapted to the route profile, with the result that a particularly energy-efficient operation can be achieved.

The respective vehicle has for example a positioning device by means of which at least one position of the vehicle on Earth can be ascertained. The positioning device uses for example a satellite-supported positioning system such as for example GPS (Global Positioning System), in order for example to ascertain the current position of the vehicle on Earth. As a result, it is possible to place the current position of the respective vehicle in relation to the route profile. For example, an area or a section of the route has the named route profile. By ascertaining the position of the respective vehicle, in particular in relation to the route profile, it is possible to specify the overall operating strategy and/or the respective individual operating strategy or to increase the first distance before the line of vehicles actually reaches the distance or the route profile.

Furthermore, it is for example possible to relate the ascertained position of the vehicle on a map, in particular on a virtual map, of the environment of the vehicle, in order as a result to ascertain features along the route profile lying ahead. These features are for example noted on the map. These features are for example the above-named elements such as the road sign, the light-signal system, the junction, the incline, the decline, the crest, the dip, and/or the bend. As a result, the overall operating strategy or the individual operating strategy can be particularly well adapted to the route profile, in order for example to prevent unnecessary accelerations and/or braking processes of the respective vehicle. Overall, a particularly energy-efficient operation can be achieved.

The invention also includes a device which is designed to carry out the method according to the invention. Advantages and advantageous embodiments of the method according to the invention are to be considered advantages and advantageous embodiments of the device according to the invention.

The device comprises for example the above-named computing device, by means of which the actuators can be triggered in order, as a result, for example to regulate or control the line of vehicles or to move the vehicles, in particular automatically or autonomously. In particular, the device is designed to operate the respective drive trains of the vehicles accordingly, in order to drive and/or brake the vehicles, in order, as a result, to implement the respective individual operating strategy or the overall operating strategy.

The respective vehicle is for example a motor vehicle which comprises at least one propulsion engine for driving the motor vehicle. The propulsion engine is for example an internal combustion engine. Alternatively or additionally, it is conceivable that the propulsion engine is an electric engine. In particular it is conceivable that the respective vehicle is designed as an electric vehicle or hybrid vehicle. In particular it is conceivable that the respective vehicle is a commercial vehicle. The method according to the invention or the device according to the invention can particularly advantageously be used in commercial vehicles, the economic feasibility of which is dependent in particular on energy consumption, wherein the energy consumption of the commercial vehicle can be kept particularly low by means of the method or by means of the device. In particular in commercial vehicles with large dimensions, driving in convoy has a particularly positive effect on energy consumption, as in particular the aerodynamic resistance of the commercial vehicles can be kept low by driving in convoy.

Further advantages, features, and details of the invention result from the following description of preferred embodiments as well as the drawings. The features and combinations of features named previously in the description, as well as the features and combinations of features named below in the description of the features or in the figures alone can be used not only in the respectively indicated combination, but also in other combinations or in isolation without going beyond the scope of the invention.

### BRIEF DESCRIPTION OF THE DRAWINGS

FIG. 1 shows a schematic representation of a line of vehicles to illustrate a method for moving, in particular regulating or controlling, the line of vehicles;

FIG. 2 shows a further schematic representation of the line of vehicles to illustrate a first embodiment of the method in a first case of application;

FIG. 3 shows a further schematic representation of the line of vehicles to illustrate the method according to a second embodiment in a first case of application;

FIG. 4 shows a further schematic representation of the line of vehicles to illustrate a the method according to a third embodiment in the first case of application;

FIG. 5 shows a diagram to illustrate the method in a second case of application,

FIG. 6 shows a diagram to illustrate the method in a third case of application;

FIG. 7 shows a diagram to illustrate the method in a fourth case of application; and

FIG. 8 shows a schematic representation of the line of vehicles to illustrate the method.

### DETAILED DESCRIPTION OF THE DRAWINGS

The same or functionally similar elements are provided with the same reference signs in the figures.

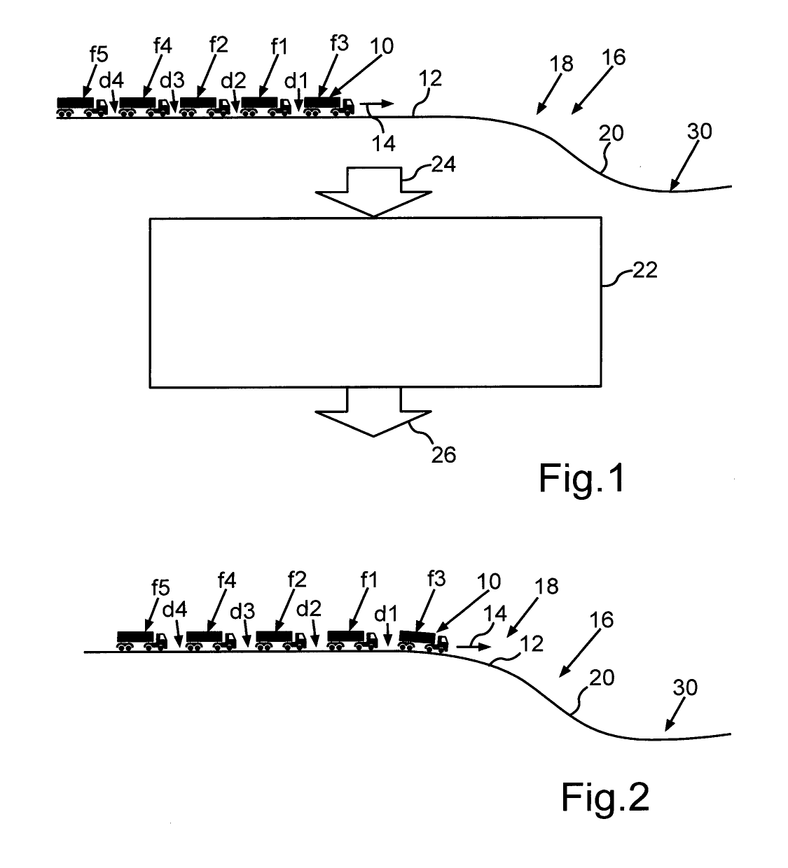

FIG. 1 shows, in a schematic side view, a line of vehicles all numbered 10, also called line, which has a first vehicle f1 and at least one second vehicle 12 following the first vehicle f1. It can be seen from FIG. 1 that the line of vehicles 10 comprises in this instance exactly five vehicles, with the result that a third vehicle f3, a fourth vehicle f4 and a fifth vehicle f5, in addition to the first vehicle f1 and the second vehicle f2, are vehicles of the line of vehicles 10. The line of vehicles 10 is formed by vehicles f1-5 being moved, i.e., driven, in a line along a route 12. In other words, vehicles f1-5 drive in convoy. As part of the line of vehicles 10 or the convoy, the vehicles f1-5 are moved consecutively or successively, in particular in a direction of travel of the line of vehicles 10 illustrated by an arrow 14 in Fig. I.

It can be seen from FIG. 1 that the vehicles f1-5 are in this instance motor vehicles in the form of commercial vehicles. The respective vehicle f1-5 comprises a drive train, not shown in more detail in the Fig., for driving and braking the respective vehicle f1-5. The drive train comprises for example at least one propulsion engine for driving the respective vehicle f1-5, wherein the propulsion engine can for example be designed as an internal combustion engine or electric engine, in particular it is conceivable that the respective vehicle f1-5 is designed as a hybrid vehicle and, as propulsion engines, comprises at least one internal combustion engine and at least one electric engine. Furthermore, the respective drive train can comprise a gearbox which respectively has a plurality of gears which can be engaged or shifted. Furthermore, the drive train comprises for example at least one braking system for braking and thus slowing down the respective vehicle f1-5. Furthermore, it is provided that the respective drive train comprises actuators, by means of which respective components of the drive train can be actuated or operated. The named components are for example the above-named propulsion engine or the above-named propulsion engines, the gearbox and/or the braking system.

A method for moving, in particular controlling or regulating, the line of vehicles is described below. As part of the method, the line of vehicles 10 is moved i.e., controlled or regulated, for example by means of a computing device not represented in the Fig., in particular an electronic computing device. In other words, the vehicles f1-5 of the line of vehicles 10 are moved, in particular controlled, by means of the computing device, with the result that the line of vehicles 10 or vehicles f1-5 are moved, for example automatically or automatedly or autonomously, by means of the computing device. Thus, for example the above-named convoy of vehicles f1-5 is carried out by means of the computing device, in particular autonomously or automatically. For this, the computing device controls for example the above-named actuators, whereby the respective drive train can be operated via the respective actuators, in particular automatically or autonomously, by means of the computing device. In this way it is for example possible that, by means of the computing device, respective driving forces or driving torques for driving or accelerating the respective vehicles f1-5 and/or, by means of the computing device, braking forces or braking torques for respective braking of respective vehicles f1-5, can be set or effected in particular automatically or autonomously via the respective actuators.

Thus, for example a longitudinal dynamics regulation of respective vehicles f1-5 takes place via the actuators, by means of the computing device, wherein this longitudinal dynamics regulation can take place automatically or autonomously by means of the computing device. “Longitudinal dynamics regulation” is understood to mean that, by means of the computing device, respective speeds and thus for example respective accelerations and/or braking processes to achieve the respective speeds are effected, in particular automatically or autonomously, via the actuators. As a result, it is for example possible to bring about respective speeds of the respective vehicles f1-5 without a respective driver of the respective vehicle f1-5 doing anything. As a result, it is for example possible to move the vehicles f1-5 at respective, particularly short, distances to each other along the route 12, in particular by means of the computing device, and simultaneously achieve a particularly safe convoy, this means that the probability of accidents remains low, as for example the drivers of vehicles f1-5, in particular their reaction times, can be ruled out as potential causes of accidents or sources of accidents.

The named computing device for carrying out the method comprises for example respective computing devices, in particular electronic computing devices, such as for example control devices, of vehicles f1-5; wherein these control devices for example exchange data in order to achieve, i.e., carry out, the method and thus the convoy. Alternatively or additionally, it is conceivable that the computing device comprises at least one computing device which is external relative to vehicles f1-5, in particular an electronic computing device, such as for example a server, wherein the external computing unit exchanges data for example with vehicles f1-5, in particular wirelessly communicated. Furthermore, the computing device can comprise exactly one computing device at least of one of vehicles f1-5. A line of vehicles comprises at least two vehicles which are moved along a route consecutively or successively. For the sake of clarity, the method is described at corresponding points below, in principle using the first vehicle f1 and the second vehicle f2, unless indicated otherwise.

As part of the method, the vehicles f1-5 of the line of vehicles 10 are moved at least temporarily at a specifiable, constant distance d1-4 to each other along the route 12 on the basis of a specifiable overall operating strategy which is assigned to the line of vehicles 10. The distances d1-4 are at least temporarily constant and particularly short, with the result that the aerodynamic resistance can be kept low. As a result, a particularly energy-efficient operation of respective vehicles f1-5 and thus line of vehicles 10 overall can be achieved. The overall operating strategy is specified for example by the computing device. For this, for example the overall operating strategy is ascertained or calculated, and ultimately specified, by means of the computing device. The first distance d1-5 is a component of the overall operating strategy.

As explained in even more detail below, to achieve a particularly energy-efficient and thus low energy consumption, in particular fuel-efficient, journey of the line of vehicles 10 along the route 12, it is now provided that a respective individual operating strategy is specified depending on a route profile 16 lying ahead of the route 12 of the line of vehicles 10, for at least two of vehicles f1-5 of the line of vehicles 10, for example for the first vehicle f1 and for the second vehicle f2, wherein the individual operating strategies differ from one another. This means that, by means of the computing device for the first vehicle f1, a first individual operating strategy and for the second vehicle f2 a second individual operating strategy differing from the first individual operating strategy, is ascertained or calculated and specified, with the result that, after ascertaining and specifying the respective individual operating strategy along the route profile 16, the first vehicle f1 is moved, i.e., driven, on the basis of the first individual operating strategy and the second vehicle f2 is moved on the basis of the second individual operating strategy. The individual. operating strategies differ for example in respect of their speed profiles or speed trajectories for the respective vehicles f1 and f2, with the result that the respective vehicles f1 and f2 are moved along the route profile 16, for example at speeds which differ from each other. This is understood to mean that the respective vehicles f1 and f2 have different speeds at at least one point of the route profile 16 because of the different individual operating strategies.

FIGS. 1 to 4 illustrate a first case of application in which the method is used. In this first case of application, the route profile 16 lying ahead has a crest 18 to which a decline 20 is connected. The line of vehicles 10 thus firstly approaches the crest 18 and thus the first case of application, wherein it is ascertained, for example on the basis of a forecast horizon, that the route profile 16 lying ahead has the crest 18, This means that it is ascertained, by means of the computing device, that the line of vehicles 10 lies ahead of the route profile 16 and thus the crest 18, before the line of vehicles 10 actually reaches route profile 16, i.e., the crest 18. This is possible in particular for example because vehicles f1-5 comprise respective positioning devices, wherein by means of the respective positioning device, at least one respective position of the respective vehicle f1-5 on Earth can be detected. For this, the respective positioning device uses for example a satellite-supported navigation system such as for example GPS (Global Positioning System). By ascertaining the respective position of the respective vehicle f1-5, it is possible to place the respective vehicle f1-5, in particular its position, in relation to the environment of the line of vehicles 10 and thus in relation to the route 20, in order as a result to ascertain that the route profile 16 and thus the crest 18 lies ahead of line of vehicles 10.

In particular depending on a current speed, by means of which the line of vehicles 10 is moved along the route 12, it can be ascertained at what time or in which time period the line of vehicles 10 will reach the route profile 16 proceeding from a first point in time. For example, the line of vehicles 10 reaches the route profile 16 at a second point in time chronologically subsequent to the first point in time. After reaching the route profile 16. the line of vehicles 10 is moved along the route profile 16, with the result that the line of vehicles 10 drives or passes through the route profile 16. After passing through or driving the route profile 16, i.e., after the line of vehicles 10 has been moved along the route profile 16, the route profile 16 lies at a third point in time behind the line of vehicles 10, chronologically subsequent to the second point in time, with the result that the line of vehicles 10 has passed through or driven the route profile 16 at the third point in time.

If the line of vehicles 10 approaches in this case the first case of application, i.e., the crest 18, an advantageous or optimal formation and/or an advantageous or optimal driving trajectory is ascertained for the line of vehicles 10 for example with an operating strategy unit 22 of the computing device, This is understood to mean that the formation and the driving trajectory are ascertained such that an energy-optimal, i.e., an energy-efficient, driving of the route profile 16 and in this instance the crest 18, is possible. The named driving trajectory comprises for example parameters which characterize the driving of the route profile 16. Such a parameter is for example the speed with which the line of vehicles 10 or the respective vehicle f1-5 is or are moved along the route profile 16. Alternatively or additionally, the parameters may be a driving torque and/or braking torque and/or a gear selection. For example, the respective parameter is specified for each of the vehicles f1-5 and thus set and effected via the computing device of the actuators in the described manner.

The operating strategy unit 22 obtains input variables 24. These input variables 24 are for example a set speed of the line of vehicles 10, the distances d1-4 or respective values, in particular actual values, of the distances d1-4, the number of vehicles of the line of vehicles 10, the type of vehicles f1-5, the length of the respective vehicle f1-5, the wind regime, in particular in the environment of the line of vehicles 10, a traffic situation or a volume of traffic, and/or an incline horizon. Depending on these input variables 24, for example the above-named overall operating strategy and/or the above-named respective individual operating strategy is calculated and thus ascertained by means of the computing device, in particular by means of the operating strategy unit 22. In summary, the individual operating strategies and the overall operating strategy are also called strategy or driving strategy.

The respective driving strategy is calculated or ascertained for example by means of the method of forecast simulation in particular in conjunction with optimization or heuristics, wherein for example a weighing-up takes place between aerodynamic advantage due to short distances d1-4 and kinematic advantage due to, in contrast, longer distances d1 4. Finally, the operating strategy 22 provides output variables 26. These output variables 26 are for example the individual operating strategies and the overall operating strategy which comprises a formation of the line of vehicles 10 which is optimal, in respect of energy consumption, with a respective optimal driving trajectory for each of vehicles

FIG. 2 illustrates a first embodiment of the method in the first case of application. If the input variables 24 characterize for example a high volume of traffic and/or unfavorable wind regime and/or a sustained large-scale topography of the route profile 16 lying ahead, then the line of vehicles 10 remains as a whole formation. For example, it is ascertained by means of the operating strategy unit 22 that, in respect of driving the route profile 16 lying ahead, which for example is formed by a route section lying ahead of the route 12, it is most energy-efficient to keep the line of vehicles 10 together as a whole formation or line formation at short, at least substantially constant, distances d1-4, and to carry out the first case of application as a whole. For this, the overall focal point of the line of vehicles 10 is determined, for example in advance, i.e., before driving route profile 16. Furthermore, for example the average rollability and the load capacity over all vehicles f1-5 which make up the line are ascertained, with the result that an energetically optimized driving trajectory, in this instance as a crest trajectory, is calculated for the line formation representing the one overall formation, relative to the line of vehicles 10. This crest trajectory is then broken down into the individual vehicles f1-5 of the line of vehicles 10, in order ultimately to move the line of vehicles 10 as a whole, i.e., as the whole line formation along the route profile 16.

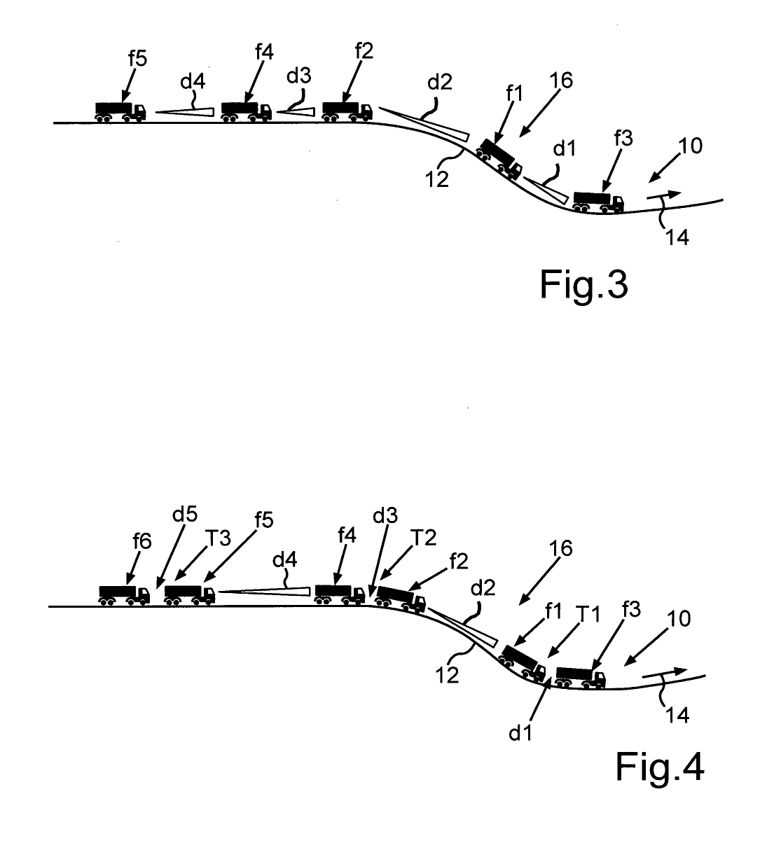

FIG. 3 shows a second embodiment of the method in the first case of application. The second embodiment shows for example ascertaining, using the input variables 24, that there is a low volume of traffic and/or favorable wind regime, for example tailwind, and/or a small-scale topography. As is explained below in yet more detail, in the second embodiment it is provided to extend the line of vehicles 10, with the result that each vehicle f1-5 can carry out its own optimal crest trajectory.

In other words, it is provided in the second embodiment, as already described, for example for the vehicle f1 and the vehicle 12, to calculate and specify the respective individual operating strategy depending on the route profile 16. As part of the overall operating strategy, the distance d2 between the vehicles f1 and f2 is increased before the line of vehicles 10 or the vehicles f1 and f2 actually reach the route profile 16. Thereupon, the respective vehicle f1 or f2 is moved along the route profile 16 and thus along the crest 18 on the basis of the respective individual operating strategy. After passing through the route profile 16, the line of vehicles 10 as a whole is moved on the basis of the overall operating strategy. Therefore, it is provided, for example, that the distance 2 between vehicles f1 and f2 is reduced again after passing through the route profile 16.

This second embodiment overall is illustrated using the vehicles f1-5. From the example of the vehicles f3 and f5, it can be seen that the distance d4 of the vehicles f4 and f5 is increased before the vehicles 14 and f5 reach the route profile 16. The distance d4 between vehicles f4 and f5 is increased by the vehicle f4 traveling ahead of vehicle f5 and/or vehicle f5 following vehicle f4, in order to make possible the execution of the respective individual operating strategy when passing the crest 18, without impairing vehicles f4 and f5.

From the example of vehicle f2 it can be seen that the respective individual operating strategy is implemented finally upon reaching the route profile 16. Furthermore, from the example of vehicles f1 and f3 it can be seen that, in particular after passing the route profile 16, and because the distance d1 between vehicles f1 and f3 has been increased before reaching route profile 16, the vehicle f1 catches up again with the one in front, i.e., vehicle f3, with the result that the distance d1 which has previously been increased, is then reduced

In respect of the second embodiment, it is ascertained by means of the operating strategy unit 22 that it is energetically most favorable to extend the line of vehicles 10, i.e., the whole line formation forming a whole formation, in particular chronologically or spatially, in order to make it possible for every vehicle f1-5 to pass over individually, in particular overrun, the crest 18. As a result, the respective vehicle f1-5 can be moved along the route profile 16 individually in a particularly energy-efficient manner, with the result that as a whole an energy-efficient operation of the line of vehicles 10 can be achieved.

In order to make possible this individual passing or overrunning of the crest 18, an optimal value is determined for each vehicle f1-5 and thus for each distance d1-4 before reaching the crest 18, in particular depending on the respective load capacity and the respective rolling properties of respective vehicles f1-5. This optimal value is then set preliminarily for example by rolling out at least one of the respectively subsequent vehicles f1, f2, f4, and f5, with the result that at least one of the distances d1-4 is increased.

After the crest 18, for example in the decline 20 of the route profile 16 subsequent to the crest 18 and/or in a dip 30 of the route profile 16 subsequent to the decline 20 and/or in a plane of the route profile 16, continuous information about the line can be re-captured for example by rolling out, in which the at least one previously increased distance(s) are reduced again, with the result that distances d1-4 after passing the route profile 16 for example correspond again to distances d1-4 before passing the route profile 16 or that the distances d1-4 are for example constant again after the route profile 16, because it can be provided that the at least two of the distances d1-4 differ while passing the route profile 16 and/or that the distances d1-4 are constant before passing the route profile 16. In particular it is conceivable that the vehicles f1-5 are moved along the route profile 16, whereas the respective distances d1-4 between the respective vehicles f1-5 differ from one another or if at least two of the distances d1-4 differ from one another when passing the route profile 16.

FIG. 4 illustrates a third embodiment of the method in the first case of application. In respect of the third embodiment, it shows for example ascertaining, using input variables 24, that there is an average volume of traffic and/or corresponding wind regime and/or an average topography of route profile 16. As part of the third embodiment the line of vehicles 10 is divided in part-lines T1, T2, and T3, wherein the part-line T1 comprises the vehicles f1 and f3, the part-line T2 comprises the vehicles 12 and f4, and the part-line T3 comprises the vehicle f5 and a sixth vehicle 16 of the line of vehicles 10.

The vehicle f3 forms the lead vehicle followed by the remaining vehicles f1, f2, f4, f5, and f6, in relation to the whole line of vehicles 10. In other words, the lead vehicle is the first vehicle of the line of vehicles 10 in direction of travel. In relation to part-line T1, the vehicle f3 forms the lead vehicle. In relation to part-line T2, the vehicle 12 forms the lead vehicle and, in relation to the part-line T3, vehicle f5 forms the lead vehicle. The distance d2 is provided between the vehicles f1 and f3 of the part-line T1, the distance d3 is provided between the vehicles f2 and f4 of the part-line T2 and the distance d5 is provided between the vehicles f5 and f6 of the part-line T3. Furthermore, the distance d2 is provided between the part-lines T1 and T2, wherein the distance d4 is provided between the part-lines T2 and T3.

The distances d2 and d4 are greater than the distances d1, d3, and d5. For example, the distances d2 and d4 can be constant. Furthermore, it is conceivable that the distances d1, d2, and/or d5 are constant. It can be seen from FIG. 4 that part-line T3 increases the distance from part-line T2 in the third embodiment, in order to make possible the first case of application or the execution of the first case of application for part-lines T2 and T3, without there being a mutual impairment. For the example of part-line T2 it can be seen that part-line T2 implements the first case of application. As part of the third embodiment, for example by means of operating strategy unit 22 it is ascertained that it is most energetically favorable to extend the whole line formation in part-lines T1, T2, and T3 at least temporarily, in particular chronologically and/or spatially impaired, in order to make possible an individual running over of the crest 18 by each part-line T1-3.

For example, the respective vehicles f1 and f3 or f2 and f4 or f5 and f6 of respective part-line T1 or T2 or T3 are moved along the route profile 16 with the respective constant individual operating strategy, wherein for example the individual operating strategies of part-line T1 differ from the individual operating strategies of part-line T2 and/or from the individual operating strategies of part-line T3. To achieve the third embodiment, for example before the crest 18 for each vehicle f1-f6, the optimal distance or a respective optimal value is determined for respective distance d1-6, in particular depending on the load capacity and the rolling properties. This optimal value is then set, for example preliminarily, by rolling out the respective subsequent vehicles f1, f2, f4, f5, and f6. After route profile 16 or after crest 18, for example in subsequent decline 20 or in dip 30 or in the plane, the previously set continuous information about the line is re-captured.

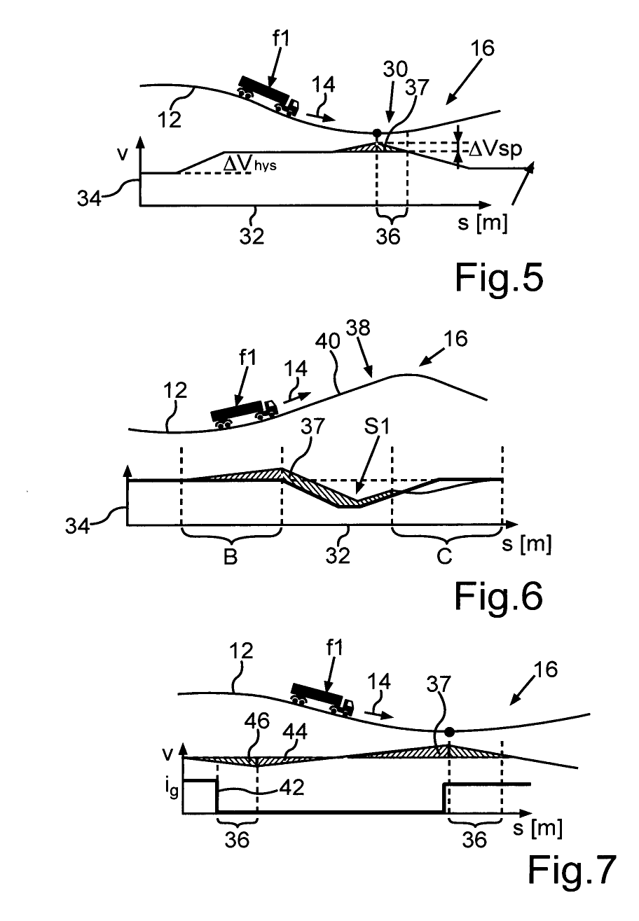

The described method, in particular the embodiments, can also be transferred to other cases of application. FIG. 5 shows a second case of application which is dip 30, with the result that—as is illustrated in the example of vehicle f1—the line of vehicles 10 is moved along or through dip 30, for example by means of the method. FIG. 5 shows a diagram, with path s, in particular in the unit meter [m], plotted on the x-axis 32, wherein speed v of the respective vehicle f1-5 is plotted on the y-axis 34 of the diagram. In FIG. 5, Δv_{hys} and Δvₛₚ denote differences in speed which can be effected by means of the method. Furthermore, a fuel consumption advantage 36 is implemented in FIG. 5, which advantage can be achieved by applying the method for example vis-à-vis the driver of vehicle f1 driving the dip 30. Furthermore, a time saving which can be achieved by the method is represented in FIG. 5,

FIG. 6 shows a third case of application which is a sharp gradient 8 and thus a steep incline 40 of the route profile 16. FIG. 6 also shows the diagram with the x-axis 32 and the y-axis 34. A forecast acceleration of vehicle f1 takes place in a region B by means of the method, with the result being the time saving 37. Coasting mode or overrun mode takes place in a region C following region B, with the result that fuel can be saved. Furthermore, a saving of a gear change takes place at point S1, in particular compared with when the driver of vehicle f1 drives through the dip 30.

Furthermore, FIG. 7 shows a fourth case of application in which a forecast rolling operation is carried out. A course 42 is engaged in the diagram, which illustrates a translation i_{g} of the gearbox of vehicle f1 and thus a gear change of gearbox. Furthermore, a course 44 illustrates the speed of vehicle f1. The fourth case of application is firstly a delay 46 which is, however, at least compensated by time saving 37. The advantage of the method in the fourth case of application is above all savings in energy consumption 36.

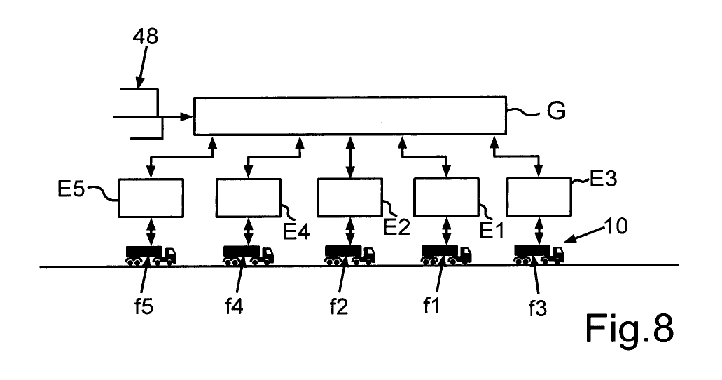

FIG. 8 shows finally a further schematic representation of the line of vehicles 10 for illustrating the method as a whole. The respective individual operating strategies are denoted in FIG. 8 with E1, E2, E3, E4, and E5. Furthermore, the overall operating strategy is denoted with G. From FIG. 8 it can be particularly well seen that the respective vehicles f1-5 are indeed driven along route profile 16 on the basis of the respective, individual operating strategies E1-5, however this takes place as part of the superordinate and thus an overall operating strategy G representing a superimposed operating strategy. This means that the vehicles f1-5 or their individual operating strategies E1-5 are not completely loosened by overall operating strategy G, but the respective individual operating strategies E1-5 are coordinated and carried out on the basis of or using the overall operating strategy G, with the result that the line of vehicles 10 is operated before route profile 16 and thereafter on the basis of the overall operating strategy G. The individual operating strategies E1-5 are thus individual, locally-operating strategies, which however are interlinked via the overall operating strategy G. As already explained, the superimposed operating strategy (overall operating strategy G) for example is ascertained or calculated and ultimately specified in a cloud or in a backend or in at least one of vehicles f1-5. In other words, it is conceivable that the above-named computing device, by means of which the overall operating strategy U and/or the respective individual operating strategies E1-5 are calculated and specified, comprises at least one computing device, in particular at least one electronic computing device, of at least one of the vehicles f1-5 of the line of vehicles 10.

The overall operating strategy G is ascertained and specified depending on at least one input variable 48. In this instance, three input variables 48 are provided. These input variables 48 are the volume of traffic, the wind regime or the wind information, and the topography or the course of topography of the route profile 16. At least one of these three input variables 48 is used in order to calculate or ascertain the overall operating strategy G, depending on the at least one input variable. The individual operating strategies E1-5 are interlinked, and/or linked to the overall operating strategy G and thus for example the computing device for example via a V2V communication, i.e., via a vehicle-to-vehicle communication, with the result that the vehicles f1-5 exchange data, in particular directly. Alternatively or additionally, the named linking takes place via V2X communication, via a vehicle-to-infrastructure communication.

Overall it can be seen that for example depending on the traffic situation and/or weather and/or topography and/or number of vehicles in the line of vehicles 10 and/or speed etc., an estimation or simulation can take place in particular at any time as to whether a single overall line, a specifiable number of part lines separated from one another or individual vehicles is or are advantageous for driving the route profile 16 lying ahead, in order to achieve an energy-efficient driving of the route profile 16. With separated sub-lines or part-lines or part-groups, as well as with individual vehicles, a determination or estimation or simulation takes place for example repeatedly as to whether possibly an individual overall formation is possibly more energy favorable. For example, it is provided that, at the point in time of the increase in distance or separation of the line of vehicles 10, already a road point navigation or a point in time is known at which a reunification of the line of vehicles 10, i.e., a reduction in distance, takes place. In particular, such a point in time or point in the route is predetermined, This predetermined point in time or point in the route is normally also maintained. If, however, there are changes to boundary conditions, then a re-evaluation can also lead to another result, with the result that for example a reunification, i.e., a forming of the overall formation is preferred or deferred or delayed chronologically and/or locally.

When forming the part-lines, the/these vehicles of the part-lines need not necessarily be distributed evenly, but it can be provided that for example at least two of the part-lines differ from one another in respect of their respective number of vehicles. If, for example, a part-line has n vehicles, then a second part-line can comprise n higher or lower number of vehicles. In spite of the described separation of the individual vehicles or part-lines and in spite of the use of the individual operating strategies which differ from each other at least partially, the superimposed overall operating strategy is and remains the central controlling and regulating authority for the respective driving strategies of the vehicles, in respect of the guidance of the line of vehicles 10, whether these are similar to identical, or slightly to greatly different, in the case of being spatially separated.

1.-10. (canceled)

11. A method for moving a line of vehicles which has at least a first vehicle and a second vehicle permanently and directly following the first vehicle, comprising the steps of:
moving the first and the second vehicles at least temporarily at a specifiable, constant first distance to each other along a route on a basis of a specifiable overall operating strategy which is assigned to the line of vehicles;
wherein for each vehicle of the line of vehicles a respective individual operating strategy is specified depending on a route profile lying ahead, wherein the respective individual operating strategies differ from one another;
wherein as part of the overall operating strategy, the first distance between the first and the second vehicles is increased before the line of vehicles reaches the route profile;
wherein the first and the second vehicles are moved along the route profile on a basis of the respective individual operating strategies; and
wherein the line of vehicles is moved on the basis of the overall operating strategy after passing through the route profile.

12. The method according to claim 11, wherein the first distance between the first and the second vehicles is reduced after starting the route profile.

13. The method according to claim 11, wherein the respective individual operating strategies differ from one another in terms of a speed with which the respective vehicle is moved along the route profile.

14. The method according to claim 11, wherein:
the line of vehicles has a third vehicle driving in front of the first vehicle and a fourth vehicle following the second vehicle;
wherein when moving along the route profile, the first vehicle and the third vehicle form a first part-line in which the first vehicle and the third vehicle are moved along the route profile at a second distance to each other;
wherein when moving along the route profile, the second vehicle and the fourth vehicle form a second part-line in which the second vehicle and the fourth vehicle are moved along the route profile at a third distance to each other;
wherein at least after increasing the first distance, the first distance is greater than the second distance and greater than the third distance.

15. The method according to claim 14, wherein the second distance and/or the third distance remains constant at least when moving along the route profile.

16. The method according to claim 14, wherein after passing through the route profile and after reducing the first distance, the first distance corresponds to the second distance and the third distance.

17. The method according to claim 11, Wherein the respective individual operating strategies and/or the overall operating strategy is ascertained depending on one or more of: a respective weight of the respective vehicle, at least one friction value characterizing a friction of the respective vehicle, a respective driving resistance of the respective vehicle, a wind regime in an environment of the respective vehicle, a number of vehicles in the line of vehicles, a respective length of the respective vehicle, and a traffic situation.

18. The method according to claim 11, wherein the overall operating strategy and/or the respective individual operating strategies are ascertained by a forecast simulation in which a movement of the line of vehicles along the route profile is simulated before the line of vehicles is moved along the route profile,

19. The method according to claim 11, wherein the route profile lying ahead includes one or more of: a road sign, a light-signal system, a junction, an incline, a decline, a crest, a bend, and a dip.

20. A device which carries out the method according to claim 11.
